(19) United States
(12) Patent Application Publication
(10) Pub. No.: US 2016/0107013 A1
(43) Pub. Date: Apr. 21, 2016

(54) A ROBOTIC SUPPLY SYSTEM

(71) Applicant: ISRAEL AEROSPACE INDUSTRIES LTD., Lod (IL)

(72) Inventor: Tamir YAACOV, Tzofim (IL)

(21) Appl. No.: 14/889,715

(22) PCT Filed: May 4, 2014
(86) PCT No.: PCT/IL2014/050402

§ 371 Date: Nov. 6, 2015

(30) Foreign Application Priority Data
May 13, 2013 (IL) 226322

(51) Int. Cl. A62C 33/00; G02B 6/44; B25J 9/06; H02G 3/04; A62C 31/00; F16L 3/16

(52) U.S. Cl. CPC A62C 33/00; A62C 31/00; F16L 3/16; B25J 9/06; B25J 9/065; H02G 3/04; G02B 6/4415; G02B 6/4436; Y10S 901/27

(57) ABSTRACT

A robotic supply system is provided having an elongated conduit for supplying material therethrough to a remote location. The conduit includes a proximal end configured for being connected to a source of the material and a distal end for dispensing the material. The robotic supply system further includes a robotic arrangement configured for bringing at least the distal end to the remote location and so disposed relative to the conduit and coupled thereto, that the conduit surrounds at least a majority of the circumference of at least a portion of the robotic arrangement thereby providing protection thereto. The conduit further includes an outer portion for supplying the material, an inner portion for holding the robotic arrangement and enveloped by the outer portion, and a wall separating the outer and inner portions.

### TECHNOLOGICAL FIELD

The presently disclosed subject matter relates to a robotic supply system in general and in particular to a supply conduit having a robotic arrangement coupled thereto.

### BACKGROUND

Robotic systems are known and include a variety of electro-mechanical arrangements for performing a wide range of tasks. An example of such system is a snake robot which is typically constructed by chaining together a number of independent links The snake robot is configured to maneuver and thus can be utilized to maneuver items to remote locations. According to one example a snake robot is utilized for extinguishing fire and is equipped with a water pipe and nozzles at the front end thereof configured for delivering water to a remote location. An example of such system is Anna Konda which is a water-powered fire fighting snake robot developed by The Foundation for Scientific and Industrial Research at the Norwegian Institute of Technology (SINTEF). The robot is capable of slithering to places human firefighters cannot safely go and by attaching the robot to the end of a fire-hose it can extinguish fires that would otherwise be unstoppable.

### GENERAL DESCRIPTION

There is provided according to one aspect of the presently disclosed subject matter a robotic supply system. The system includes an elongated conduit for supplying material therethrough to a remote location, the conduit having a proximal end configured for being connected to a source of the material and a distal end for dispensing the material; a robotic arrangement configured for bringing at least the distal end to the remote location and so disposed relative to the conduit and coupled thereto, that the conduit surrounds at least a majority of the circumference of at least a portion of the robotic arrangement thereby providing protection thereto.

The conduit can surround the entire circumference of at least a portion of the robotic arrangement. The conduit can include an outer portion for supplying the material therethrough and a inner portion for holding the robotic arrangement. The inner portion is enveloped by the outer portion and having a wall separating therebetween. The robotic supply system can further include a second conduit being disposed in the inner portion and configured to transfer therethrough a second material.

The conduit can be divided to at least a first chamber and a second chamber. The conduit can further comprise a circulating member for circulating the material in the conduit between the first chamber and the second chamber.

The protection includes thermal insulation provided by the conduit. The thermal insulation can be provided by the material. The material can be liquid. The conduit can configured to transfer material for extinguishing fire. The protection can be a mechanical protection. The mechanical protection can further be provided by the material inside the conduit.

The robotic arrangement can be a snake robot, alternatively the robotic arrangement can be a robotic arm. The robotic arrangement can extend along the elongated conduit.

According to another aspect of the presently disclosed subject matter there is provided a supply system comprising: an inner conduit for holding a content therein; an outer conduit enveloping at least a majority of the inner conduit and configured for supplying material therethrough; and a wall between the conduits separating the material from the interior of the inner conduit, thereby providing protection to the content.

The outer conduit can surround the entire circumference of the at least a majority of the inner conduit. The entire inner conduit can extend within the outer conduit.

The protection can includes thermal insulation provided by the outer conduit. The thermal insulation can be provided by the material. The material can be liquid. The outer conduit can be configured to transfer material for extinguishing fire.

The content can include a second conduit which is disposed in the inner conduit and configured to transfer therethrough a second material. The second material is a life sustaining fluid. The content can further include a robotic arrangement. The robotic arrangement is a snake robot alternatively robotic arrangement is a robotic arm. The robotic arrangement can extend along the elongated conduit. The robotic arrangement can extend along the elongated conduit. The content can further include means for transferring electronic data.

According to yet another aspect of the presently disclosed subject matter there is provided a method for forming a robotic supply system. The method comprising: forming an elongated conduit for supplying material therethrough to a remote location, the conduit having a proximal end configured for being connected to a source of the material and a distal end for dispensing the material; providing a robotic arrangement configured for bringing at least the distal end to the remote location; and disposing and coupling the robotic arrangement relative to the conduit, such that the conduit surrounds at least a majority of the circumference of at least a portion of the robotic arrangement thereby providing protection thereto.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of a the robotic supply system according to one example of the presently disclosed subject matter;

FIG. 2A is a top sectional view of a portion of the supply conduit of the supply system of FIG. 1;

FIG. 2B is a perspective partially cut-away view of a portion of the supply conduit of the supply system of FIG. 2A;

FIG. 3 is a front sectional view taken along line A-A of the supply conduit of FIG. 2B;

FIG. 4 is a top view of the robotic arrangement of the robotic supply system of FIG. 1, according to one example of the presently disclosed subject matter; and,

FIG. 5 is a perspective view of the dispensing device mounted at the distal end of the supply conduit according to one example of the presently disclosed subject matter.

### DETAILED DESCRIPTION OF EMBODIMENTS

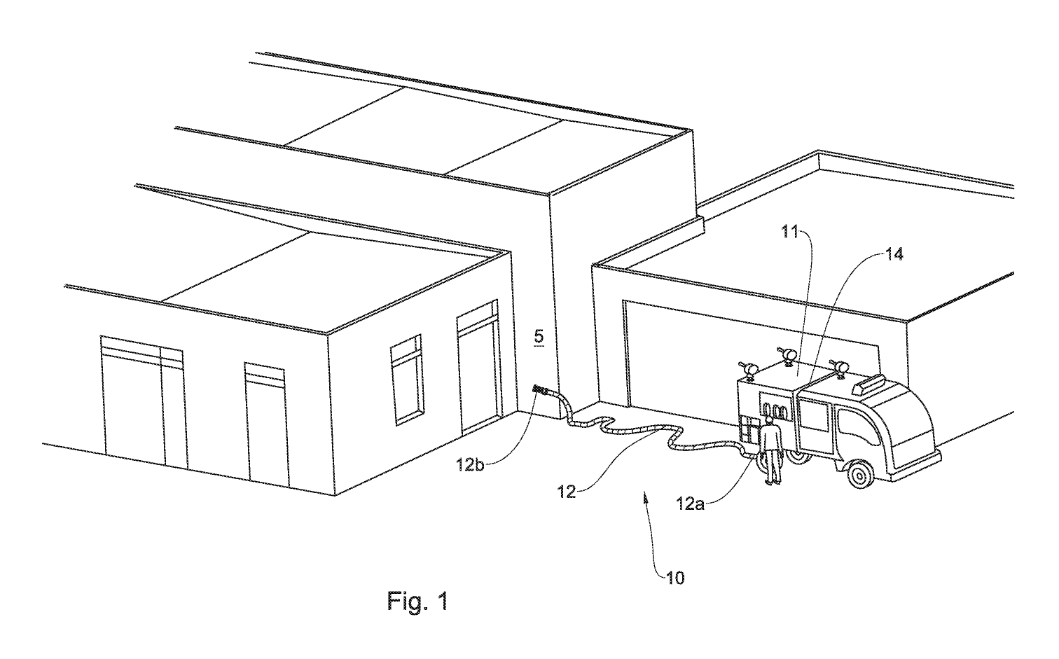

FIG. 1 shows a robotic supply system 10 having an elongated conduit 12 for supplying material, such as fluids, therethrough, to a remote location 5. The conduit having a proximal end 12a configured to be connected to a source 11 of material, here illustrated as a water tank of a fire track 14, and a distal end 12b for dispensing the material at the remote location 5.

The supply system 10 further includes a robotic arrangement, generally designated 30, configured for bringing at least the distal end 12b to the remote location 5. The robotic arrangement 30 is disposed and coupled relative to the conduit 12 in such a way that the conduit surrounds at least a majority of the circumference of at least a portion of the robotic arrangement thereby providing protection thereto. According to the illustrated example the conduit 12 surrounds the entire circumference of the robotic arrangement 30.

The conduit 12 is configured to provide the robotic arrangement 30 with protection for example, by providing thermal insulation. It is appreciated that the thermal insulation can be provided by the material disposed inside the conduit 12. For example, the conduit 12 can be configured to supply water for extinguishing fire, at the remote location 5. Thus, the water inside the conduit 12 can provide thermal protection to the robotic arrangement 30. This way, if the water is supplied to the remote location 5 where there if fire which can possibly heat up the conduit 12 and damage the robotic arrangement 30, the water maintains a low temperature relative to the temperature outside the conduit. It is appreciated that when the water is supplied to the remote location, the flow thereof ensures that the water inside the conduit 12 is maintained at low temperature.

Similarly, the protection provided by the conduit and the material therein can be a mechanical protection. In the latter the example, the water serves as a mechanical buffer, which is configured to protect the robotic arrangement from mechanical damages.

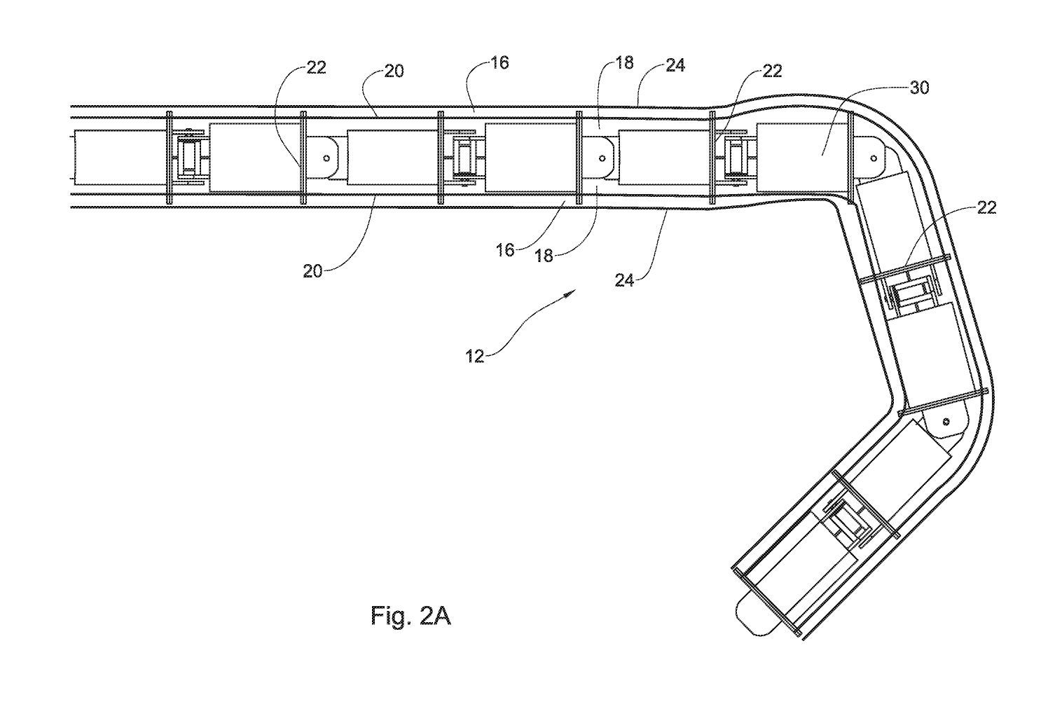

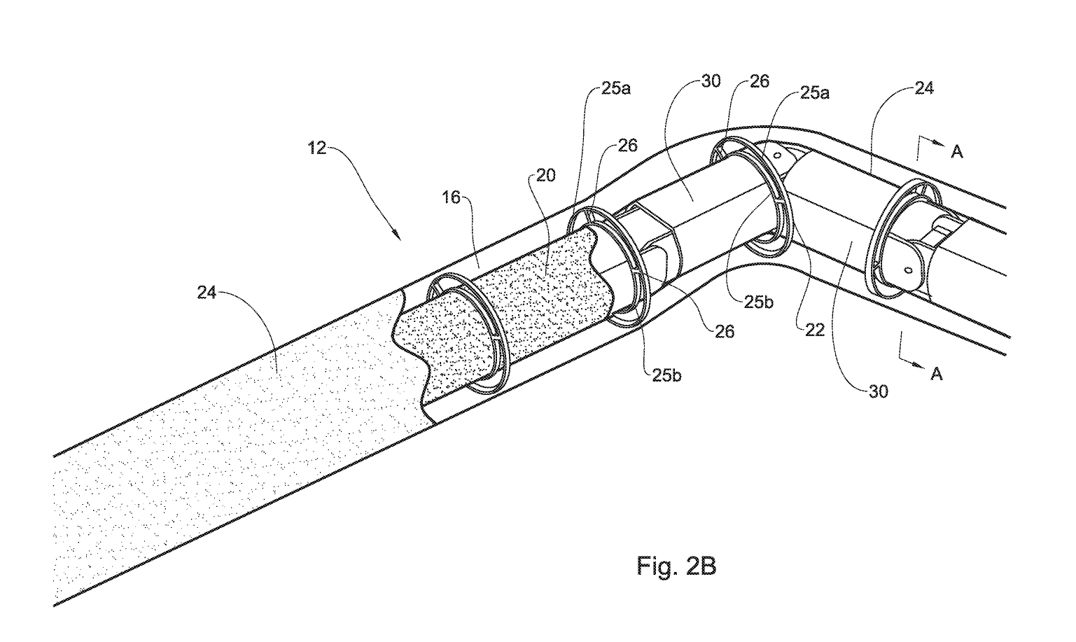

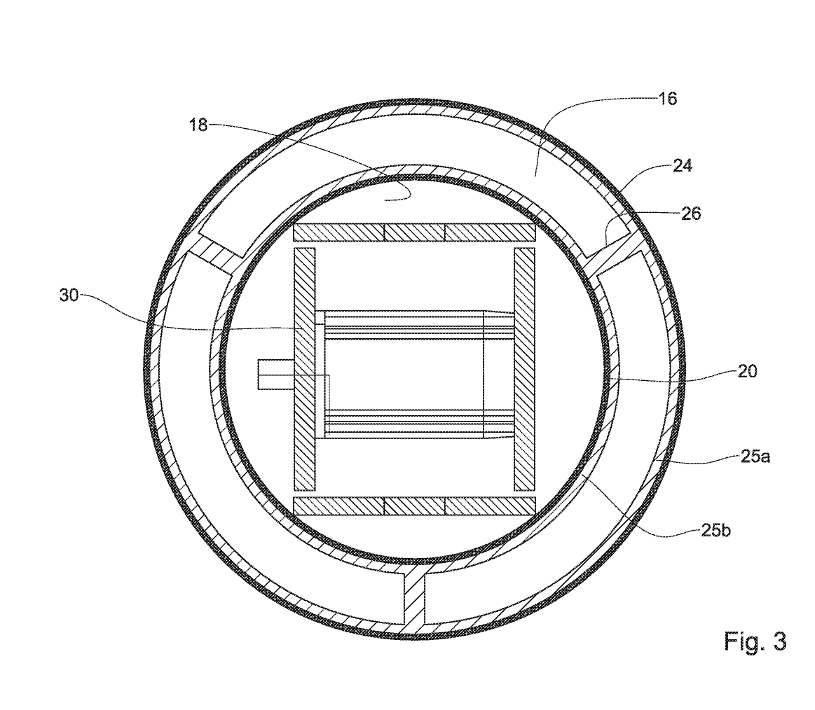

Reference is now made to FIGS. 2A, 2B, and 3 the conduit 12 according to an example includes an outer portion 16 for supplying a material therethrough and an inner portion 18 for holding the robotic arrangement 30. The inner portion 18 is enveloped by the outer portion 16 and having a wall 20 separating therebetween. The outer portion 16 is defined between the separating wall 20 and the outer layer 24, and surrounds the circumference of the inner portion 18 thereby providing protection thereto. The diameter of the inner portion 18 is adapted in accordance with the cross sectional area required for holding the robotic arrangement 30. The overall diameter of the conduit 12 however includes in addition to the diameter of the inner portion 18, the width of the outer portion 16. The width of the outer portion 16, which is the distance between the outer layer 24 and the separating wall 20. That is to say, the width of the outer portion 16 is the overall diameter of the conduit 12 less the diameter of the inner portion 18. The width of the outer portion 16, can be determined in accordance with the required flow of material transferred therethrough, the required pressure of the flow, and in accordance with the required protection provided to the robotic arrangement 30 in the inner portion 18.

It will be appreciated by those skilled in the art that the inner portion 18 and the outer portion 16 may or may not be concentric. That is to say, the outer portion 16 can be such the width thereof is not constant about the circumference of the inner portion 18. For example, the width of the outer portion 16 on one side of the inner portion 18 can be different than that of the opposing side. The width at each side of the inner portion 18 can be determined in accordance with the protection requirements of the robotic arrangement inside the inner portion 18. For example, if the robotic arrangement includes a component or a segment which is more sensitive to heat than other components, the outer portion 16 about that component can be formed with a greater width relative to other areas of the outer portion, so as to provide the required protection to the sensitive component.

According to the illustrated example, the conduit further includes a plurality of retainers 22 disposed inside the conduit 12 and configured to retain the shape of the inner portion 18 and the outer portion 16, such that the flow of material therein is not obstructed or constricted by the outer layer 24 or the separating wall 20. The retainer 22 can include a first ring 25a disposed inside the outer portion 16, configured to support the outer layer 24, and having a substantially same diameter. The retainer 22 can further include a second ring 25b disposed about the separating wall 20, and having a substantially same diameter as that of the inner portion 18. The first ring 25a can be coupled to the second ring 25b by means of one or more coupling arms 26. The retainers 22 can be disposed at any location along the length of the conduit 12 and the distance therebetween can be such the portion of conduit between two adjacent retainers is supported as required so as to allow a free flow of the material therein.

It is appreciated that the material of the outer layer 24 and the separating wall 20 is configured to allow bending thereof, as required for the operation and maneuvering of the robotic arrangement 30.

According to an example, the material transferred through the outer portion of the conduit is configured to provide thermal insulation to the robotic arrangement disposed inside the inner portion. The material, for example, water for extinguishing fire, can be dispensed at the remote location, while the conduit extends through areas having high temperature. In that case however, the temperature of the water running through the outer portion is maintained relatively low, since fresh water is constantly supplied. However, it is appreciated that in some cases even standing water are sufficient to provide the necessary thermal protection by insulating the robotic arrangement inside the inner portion 18.

According to another example of the presently disclosed subject matter, the outer portion of the conduit 12 can include two or more chambers at least one of each coupled on one end thereof to a source, and extends along the conduit from the proximal end 12a thereof to the distal end thereof 12b. Each chamber can be configured to independently transfer a material therein and to dispense the material at the remote location. The material dispensed by each of the chambers can be the same, or can be different material in each chamber. According to the latter example each of the chambers is coupled to a source tank containing the respective material transferred therethrough.

According to an example (not shown), the conduit includes a first chamber and a second chamber extending along the outer portion and configured to transfer therethrough liquid, for example, water for extinguishing fire. In order to preclude an escalation of the water temperature, the flow of the water inside the chambers is maintained, either by allowing the water to be dispensed at the remote location or by allowing the water to circulate inside the chambers.

In the latter case, which is useful when the water is not dispensed out of the conduit, the first chamber is in fluid communication with the second chamber at each end of the conduit through an aperture, such that water flowing through the first chamber can enter the second chamber through the aperture at the distal end of the conduit. Similarly, water flowing through the second chamber can enter the first chamber through the aperture at the proximal end of the conduit. This way, even in case the conduit is not configured to dispense the water, for example if the dispensing device at the distal end thereof is in the closed position, the water therein circulates and the flow thereof is maintained. Thus, water in segments of the conduit which are located in an ambient of high temperature, maintain its relatively constant temperature.

According to an example, the conduit having first and second chambers further includes a circulating member for circulating the material therein such that the material, such as the water, flows between the first chamber and the second chamber.

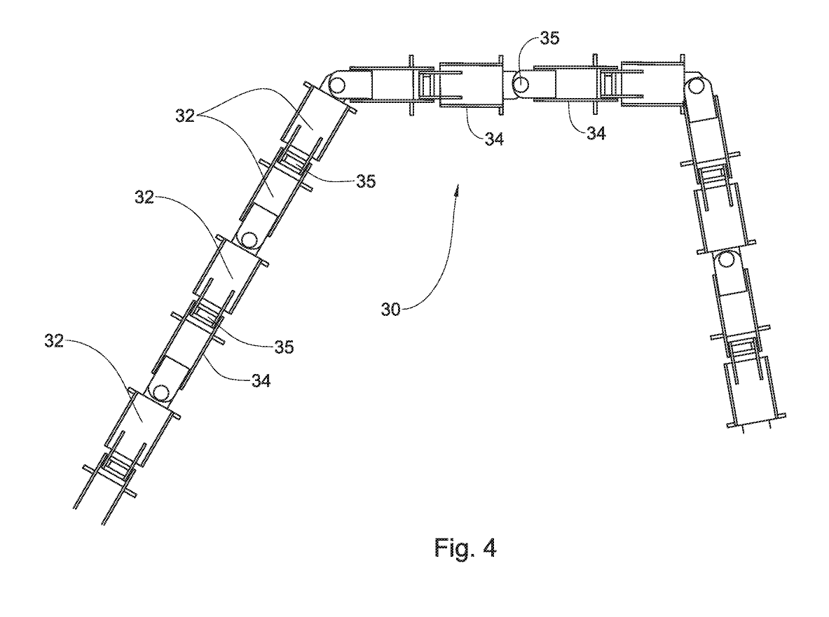

As shown in FIG. 4 the robotic arrangement generally designated 30 can be a snake robot, electrically or pneumatically operated and having a plurality of links 32 each having a rigid frame 34 configured to form a joint 35 with and adjacent link Each link can include a motor for rotating the links with respect to an adjacent link, about the joint 35. A controller is provided for coordinating the rotation of each link, and allowing a snake-like motion of the robotic arrangement 30.

It is appreciated that the robotic arrangement can be any other automated assembly such which is configured to be disposed inside the inner portion 18 of the conduit 12, and configured for bringing at least the distal end to a remote location. The robotic arrangement can be configured to extend along substantially the entire length conduit. It appreciated however, that the robotic arrangement can be extended only along a portion of the conduit which is closer to the distal end thereof. According to this example the robotic arrangement is configured to move the distal end of the conduit and pull the entire length of the conduit together with the material therein.

The robotic arrangement can be according to one example a robotic arm, which includes one or more folding joints, such that in the unfolded position the arm extends and thereby pull the conduit therewith. According to a further example the robotic arrangements can be a telescopic arm configured with a deployed and retracted positions. In the deployed position the telescopic are is extended thereby moving the conduit forwards. The conduit in this case can be an extendable pipe configured to extend when the telescopic arm shits to the deployed position.

It is appreciated that inside the inner portion 18 there can be provided other elements which require protection, such as electronic devices, optical fibers etc., which can be utilized for transfering images or other data from the remote location to an operator. Thus, the outer portion 16 and the material transferred therethrough provide protection to the electronics inside the inner portion 18 of the conduit 12.

This way, if the conduit is used for carrying water to extinguish fire inside a building, the robot arrangement maneuver the distal end 12b of the conduit 12 into the building and the water disposed in the outer portion 16 provides mechanical and thermal protection to the robotic arrangement 30. Electronic system configured to transfer images from the distal end to the outside of the building can be disposed inside the inner portion 18 so as to allow the operator outside the building to bring the distal end to the source of the fire inside the building. The water in the outer portion 16, thus, provides thermal and mechanical protection to the electronic system as well.

It is appreciated that the robotic arrangement can be configured for an automatic and autonomous maneuvering of the conduit. For example, detecting means and a controller can be provided such that the operation of the robotic supply system is automatically controlled in response to the ambient conditions. In the case of a fire fighting system, the ambient conditions can be detecting temperature above a predetermined threshold, and directing water to the suspected heat source, etc. according the another example the supply system can be a rescue system configured to supply water and other substances to survivors under ruins. The system can be configured to detect signs of life from distance and to automatically direct the system in that direction.

According to another example, other materials, such as, oxygen and medication can be transferred though the inner portion 18, to people inside the building. The water inside the outer portion 16 provides thermal protection to the materials inside the inner portion 18, thus these materials i.e. medications etc. can be used and not get spoiled by the ambient heat.

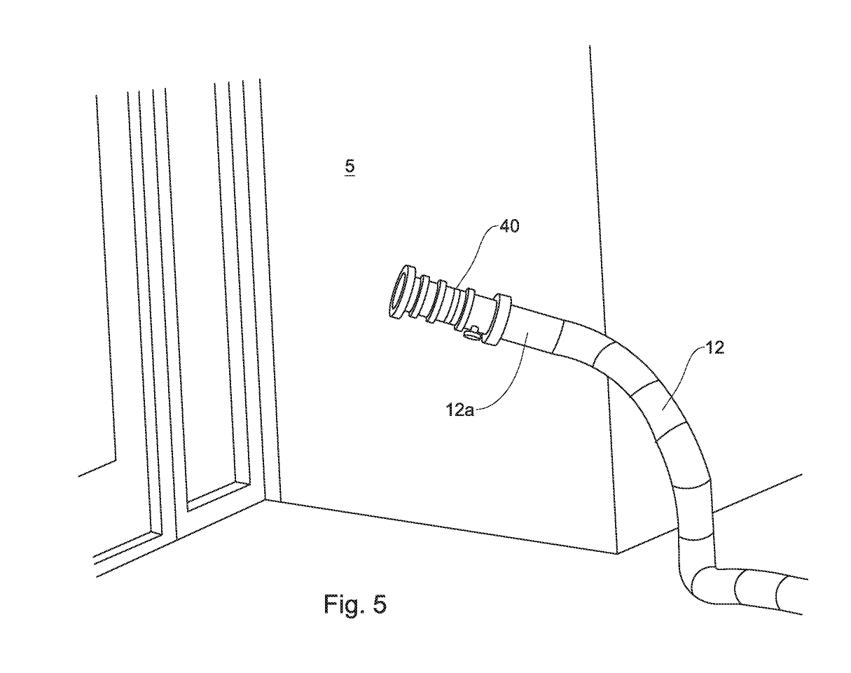

FIG. 5 illustrates a dispensing device 40 mounted at the distal end of the conduit 12 and configured to dispense the material from the conduit. The dispensing device 40 can be an electric faucet, a water hydraulic valve, or the like, and can be configured to be remotely activated and shifted from an open position wherein the material is dispense and closed position wherein the material cannot be dispensed out of the conduit.

According to an example of the presently disclosed subject matter the robotic supply system can be utilized for supplying gas to vehicles. Accordingly the conduit is configured for supplying gas, such as patrol, gasoline, Mazut, and the like therethrough to the tank of the vehicle, such as the car, plane, tracks, tanks, etc. The proximal end of the conduit in this case is configured for connecting to a gas station pump, or a large fuel tank, while the distal end thereof is configured to engage a fuel tank of the vehicle. The conduit defined an inner portion such that the gasoline in the conduit surrounds the inner portion. A robotic arrangement is provided inside an inner portion of the conduit and is configured for bringing and coupling the distal end to the filler head of the vehicle's fuel tank.

Those skilled in the art to which the presently disclosed subject matter pertains will readily appreciate that numerous changes, variations, and modifications can be made without departing from the scope of the invention, mutatis mutandis.

1. A robotic supply system, comprising:
an elongated conduit for supplying material therethrough to a remote location, the elongated conduit having a proximal end configured for being connected to a source of said material and a distal end for dispensing said material; and
a robotic arrangement configured for bringing at least said distal end to the remote location and so disposed relative to said elongated conduit and coupled thereto, such that the elongated conduit surrounds at least a majority of a circumference of at least a portion of said robotic arrangement thereby providing protection thereto;
wherein said elongated conduit includes an outer portion for supplying said material, an inner portion for holding said robotic arrangement and being enveloped by said outer portion, and a wall separating said outer and inner portions.

2. The robotic supply system of claim 1, wherein said elongated conduit surrounds an entirety of the circumference of said at least a portion of said robotic arrangement.

3. (canceled)

4. The robotic supply system of claim 1, further comprising a second conduit being disposed in said inner portion and configured to transfer a second material.

5. The robotic supply system of claim 1 wherein said elongated conduit is divided into at least a first chamber and a second chamber, and further includes a circulating member for circulating said material in said elongated conduit between said first chamber and said second chamber.

6. (canceled)

7. The robotic supply system of claim 1 wherein said protection includes thermal insulation provided by said elongated conduit.

8. The robotic supply system of claim 7 wherein said thermal insulation is provided by said material.

9. The robotic supply system of claim 1 wherein said material is liquid.

10. The robotic supply system of claim 1 wherein said elongated conduit is configured to transfer material for extinguishing fire.

11. The robotic supply system of claim 1 wherein said protection is a mechanical protection.

12. The robotic supply system of claim 11, wherein said mechanical protection is further provided by said material inside said elongated conduit.

13. The robotic supply system of claim 1 wherein said robotic arrangement is selected from the group consisting of a snake robot and a robotic arm.

14. (canceled)

15. The robotic supply system of claim 1 wherein said robotic arrangement extends along said elongated conduit.

16. A supply system, comprising:
an inner conduit for holding a content therein;
an outer conduit enveloping at least a majority of said inner conduit and configured for supplying material; and
a wall between said inner and outer conduits separating said material from an interior of said inner conduit, thereby providing protection to said content.

17. The supply system of claim 16, wherein said outer conduit surrounds an entire circumference of said at least a majority of said inner conduit.

18. (canceled)

19. The supply system of claim 16 wherein said outer conduit is divided into at least a first chamber and a second chamber, and further includes a circulating member for circulating said material in said outer conduit between said first chamber and said second chamber.

20-26. (canceled)

27. The supply system of claim 16 wherein said content includes a second conduit being disposed in said inner conduit and configured to transfer a second material.

28. (canceled)

29. The supply system of claim 16 wherein said content further includes a robotic arrangement.

30. (canceled)

31. (canceled)

32. The supply system of claim 29 wherein said robotic arrangement extends along said inner conduit and said outer conduit.

33. (canceled)

34. The supply system of claim 16 wherein said content further includes means for transferring electronic data.

35. A method for forming a robotic supply system, the method comprising:
forming an elongated conduit for supplying material therethrough to a remote location, the elongated conduit having a proximal end configured for being connected to a source of said material and a distal end for dispensing said material, the elongated conduit further including an outer portion for supplying said material, an inner portion enveloped by said outer portion, and a wall separating said outer portion and said inner portion;
providing a robotic arrangement held by said inner portion and configured for bringing at least said distal end to the remote location; and
disposing and coupling said robotic arrangement relative to said elongated conduit, such that the elongated conduit surrounds at least a majority of the circumference of at least a portion of said robotic arrangement thereby providing protection thereto.
